(19) United States
(12) Patent Application Publication
(10) Pub. No.: US 2009/0015602 A1
(43) Pub. Date: Jan. 15, 2009

(54) Contrast Ratio Enhancement System Using Asymmetrically Delayed Illumination Control

(75) Inventors: Mark Francis Rumreich, Indianapolis, IN (US); John Alan Hague, Indianapolis, IN (US)

Correspondence Address: FLETCHER YODER P.C., 7915 FM 1960 RD. WEST, SUITE 330, HOUSTON, TX, 77070, US

(73) Assignee: TTE TECHNOLOGY, INC., Indianapolis, IN (US)

(21) Appl. No.: 12/160,078

(22) PCT Filed: Jan. 11, 2006
(86) PCT No.: PCT/US2006/001195

§ 371 Date: Jul. 3, 2008

(51) Int. Cl. G09G 5/10

(52) U.S. Cl. 345/690

(57) ABSTRACT

The disclosed embodiments relate to a system and method that enhance contrast ratio of a display device using asymmetrically delayed illumination signal control. An exemplary embodiment comprises determining a pixel brightness level for a video frame, and delaying application of the illumination signal based on a change of the pixel brightness level.

### FIELD OF THE INVENTION

The present invention relates generally to display systems. More specifically, the present invention relates to a system and method for enhancing contrast ratio in certain display systems.

### BACKGROUND OF THE INVENTION

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

Liquid Crystal Displays (LCD) panels are increasingly being used for television display applications mainly due to their light weight and thin profile, as compared to Cathode Ray Tubes (CRTs). However, the performance of LCD panels is still lagging behind CRTs in a number of key areas, one of which is contrast ratio. As an example, the contrast ratio of high-end LCD panels is generally about 500:1, while for a CRT, 10,000:1 is a common ratio.

The contrast ratio may be defined as the ratio of the amount of light of the brightest white to the darkest black of a video frame. Unfortunately, due to their light transmitting properties, pixels of LCD panels transmit enough light, even when in their darkest state, such that a black colored pixel displayed on the LCD panel actually appears to be displayed as a dark gray pixel. Consequently, this significantly lowers the contrast ratio of the LCD panel, which may be more objectionable in low light viewing conditions.

Furthermore, time misalignments between pixel's raster scanning and backlight illumination in a video frame may give rise to viewer perceived artifacts. Particularly, an increase in the illumination level of the backlight coupled with the time delay associated with the pixel raster scanning may produce an objectionable “white flash” across the display device, as appreciated to those skilled in the art.

### SUMMARY OF THE INVENTION

Certain aspects commensurate in scope with the disclosed embodiments are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

The disclosed embodiments relate to a system and method that enhance contrast ratio of a display device using asymmetrically delayed illumination signal control. An exemplary embodiment comprises determining a pixel brightness level for a video frame, and delaying application of the illumination signal based on a change of the pixel brightness. In addition to LCDs, the disclosed system and method may apply to digital light displays (DLPs) and to crystal on silicon (LCOS) display systems.

### BRIEF DESCRIPTION OF THE DRAWINGS

Advantages of the invention may become apparent upon reading the following detailed description and upon reference to the drawings in which:

FIG. 1 is a block diagram of an LCD panel in accordance with an exemplary embodiment of the present invention;

FIG. 2 is a block diagram of a contrast ratio enhancing system in accordance with an exemplary embodiment of the present invention;

FIG. 3 is a block diagram of a rise/fall delay circuit in accordance with an exemplary embodiment of the present invention;

FIG. 4 is a block diagram of an exemplary graph of pixel response times for backlight illumination in accordance with an exemplary embodiment of the present invention; and

FIG. 5 is flow chart depicting a method for asymmetrically delaying backlight illumination control in accordance with an exemplary embodiment of the present invention.

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

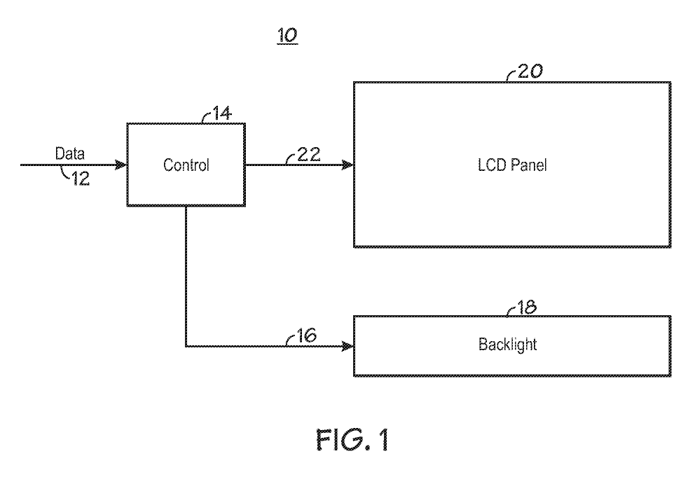

Referring to FIG. 1, a configuration of an exemplary LCD panel system 10 in accordance with an exemplary embodiment of the present invention is shown. The figure depicts an LCD panel 20 and an illumination source 18, such as a backlight controlled by a control system 14. The control system 14, receives data 12, which may include video backlight illumination and liquid crystal pixel data values. The control system 14 may use the data 12 to simultaneously adjust the backlight and the pixel values to enhance the contrast ratio of the LCD panel 20. Accordingly, data 22 outputted by the control system 14 goes into the LCD panel 20 for adjusting the pixel values. Similarly, data 16 provided by the control system 14 is transmitted into the backlight 18 for adjusting the backlight illumination of the video.

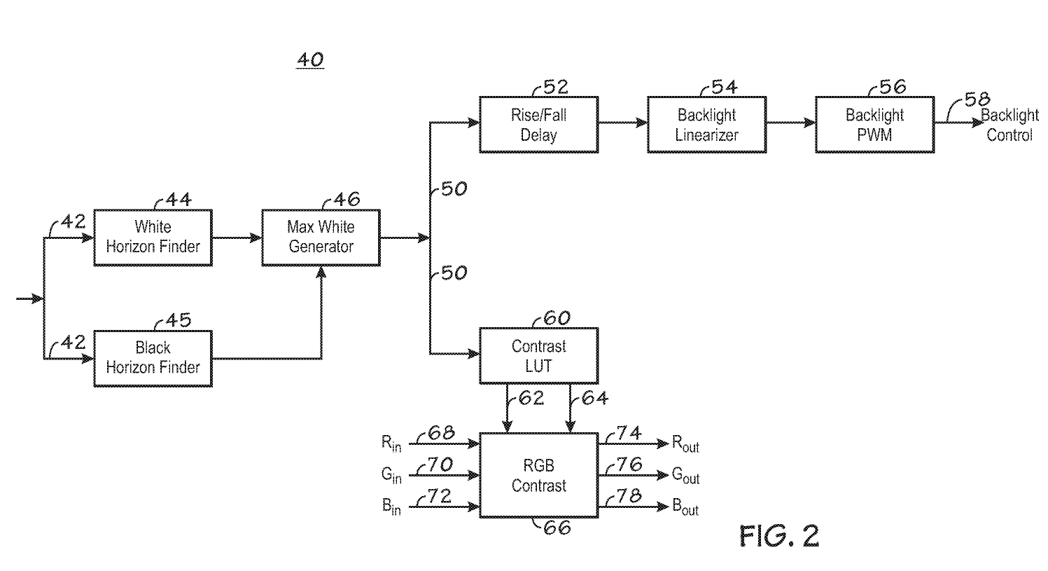

Turning now to FIG. 2, a contrast ratio enhancement control system 40 in accordance with an exemplary embodiment of the present invention is shown. The description set forth of the control system 40 pertains to components controlling the video illumination signal, such as that produced by the backlight 18, and the pixel values of the LCD panel 20. Accordingly, a white horizon finder 44 and a black horizon finder 45 receive respective backlight illumination component data 42. The white horizon finder 44 and the black horizon finder 45 respectively determine statistical information relating to the brightness, dark and near dark levels, and their distribution throughout a video frame. Information obtained by the white horizon finder 44 and the black horizon finder 45 is provided to a maximum white generator 46. The maximum white generator 46 modulates the backlight illumination while adjusting liquid crystal pixel values. In accordance with embodiments of the present invention, the two are adjusted in a complementary fashion to enhance the contrast ratio of the LCD panel 20.

The maximum white generator 46 adjusts the backlight illumination by determining the brightness of the brightest area of the video frame. This information is then utilized to illuminate the LCD panel 20, for example by cold-cathode-fluorescent (CCF) lamps. To improve the contrast ratio, a reduced backlight illumination is desired. However, as one of ordinary skilled in the art would appreciate, reducing the backlight illumination too much may cause an undesired “white reduction” of the video frame. In order to avoid this, brightness information obtained by the maximum white generator 46 is further utilized to modify the pixel values of the LCD panel to compensate for possible insufficient backlight illumination.

The maximum white generator 46 provides output data 50, used to simultaneously adjust the backlight illumination data and red, green and blue (RGB) input values of the LCD panel 20. To compensate for backlight modulation, the maximum white data 50 is further processed for modifying the pixel values of the LCD panel 20 in a non-linear gamma-corrected domain. The data 50 is further delivered to a contrast look-up table (CLUT) 60, which stores adjustment values that are formatted as an (RGB) offset 62 and an RGB gain-value 64. The RGB offset value 62 and the RGB gain-value 64 are delivered to an RGB contrast 66. Pixels values delivered to the display device (20) denoted as RGB 68-72 are combined with the RGB offset 62 and the RGB gain-value 64 to output gamma-corrected RGB pixel values 74-78.

In addition to modifying the color pixel values, the output data 50 is also delivered to backlight control circuitry, which produces backlight control data 58. Such backlight control circuitry may include a rise/fall delay 52 which compensates for time misalignments between the backlight and the pixel raster scan. As described further below this may prevent viewer perceived white flashes appearing on a screen, which are generally undesirable. The backlight control circuitry may further include a backlight linearizer 54 for compensating nonlinearities in the light characteristic of the backlight. Also included is a backlight pulse width modulator (PWM) 56 which controls the illumination level of the backlight.

The system 40, applies backlight illumination control and pixel value modification on a frame by frame basis. Hence, throughout a video frame, pixels may be raster scanned on a screen, for example, from top to bottom. At the same time, the display device may comprise a backlight illumination apparatus, such as a CCF lamp, which applies backlight illumination to all the pixels of the display device at the beginning of each frame simultaneously. Consequently, in every frame there exists a time delay between the scanning of the pixels values and the backlight illumination. This is especially true for pixels disposed at the bottom of the screen since they are scanned last. Further, video frames comprising such time delays coupled with low to high transitions of the backlight may result in an artifact perceived by a viewer as an objectionable white flash. It is therefore desirable to eliminate such an artifact. In order to do so, the backlight illumination may be delayed by certain preset times in each video frame. Such delays may depend on the transitions of the illumination levels applied by the backlight for a video frame. This effectively time-aligns the raster scan of the pixels at the bottom of the screen with the backlight illumination, preventing the appearance of the white flash. In an exemplary mode of operation, rising illumination level may require delaying the backlight by durations longer than durations required for falling illumination levels. Accordingly, controlling time delays applied to the backlight illumination is achieved by the rise/fall delay 52.

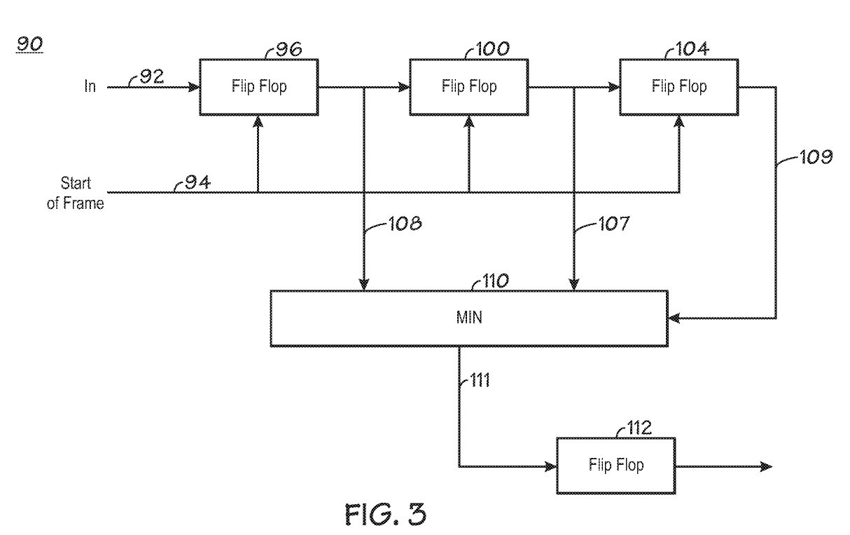

Referring now to FIG. 3, a block diagram of a rise/fall delay circuit 90 is illustrated in accordance with an exemplary embodiment of the present invention. The system 90 is provided with illumination data 92, which is delivered to flip-flop circuits 96, 100, 104. The flip-flop circuits 96, 100, and 104 are connected in series relative to each other, and each of them may delay the backlight illumination signal, for example by one frame. Since delaying the backlight illumination is done on a frame by frame basis, the flip-flop circuits 96, 100, 104 are further provided with a start of frame signal 94 to indicate frame initiation. Thus, the circuits 96, 100 and 104 are configured to produce delayed backlight data 108, 107 and 109 respectively. In this exemplary embodiment, the later output data 108, 107 and 109 delay backlight signals by one, two and three frames respectively.

Further, the signals 108, 107 and 109 are delivered to circuit 110, which identifies a minimum signal from these three inputs and produces output data signal 111. In identifying the minimum signal, the circuit 110 ensures that the output backlight illumination data 111 is delayed in accordance with transitions of the backlight illumination. Consequently, the circuit 90 via the data 111 effectively applies a one-frame delay to the backlight illumination signal as the signal transitions in a downward direction. Similarly, a three-frame delay is effectively applied whenever the backlight illumination signal transitions in an upward direction. In this manner, the backlight illumination signal is delayed asymmetrically in order to mitigate the time misalignments between the raster scanning of the pixels and the backlight signal. The system 90 further applies a one-frame delay to the backlight to account for an inherent slow response time of the pixels disposed in the display device. Thus, delayed signal 111 produced by the circuit 110 is delivered to a flip-flop circuit 112 for the backlight illumination control 58 (FIG. 2).

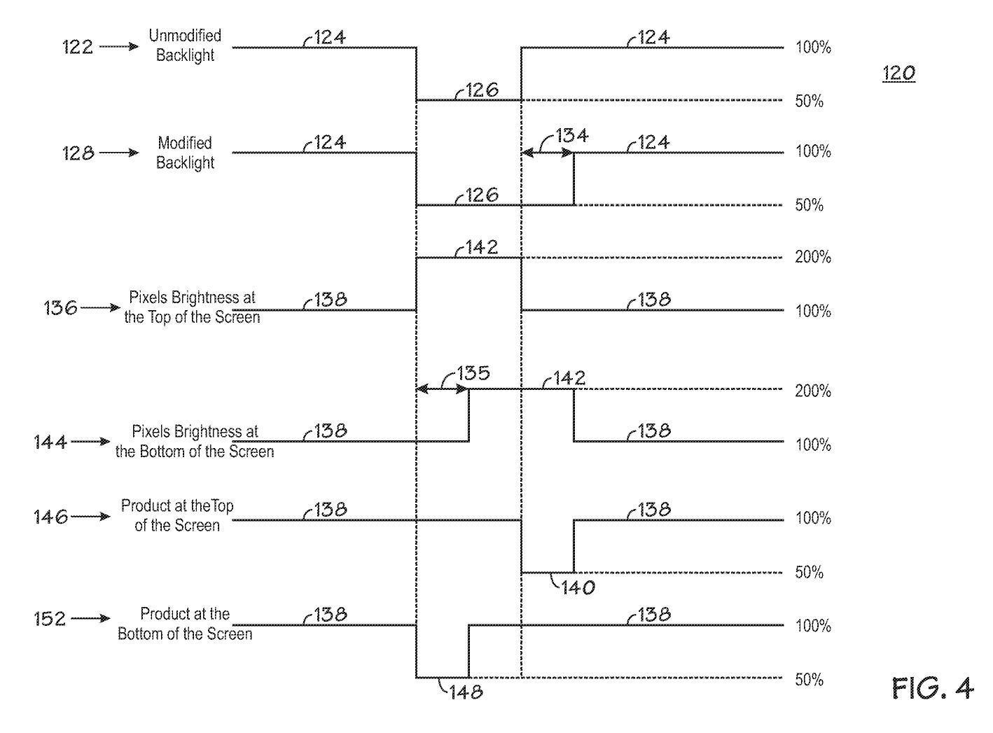

FIG. 4 is an exemplary graphic depiction of the backlight illumination and pixel brightness in accordance with an exemplary embodiment of the present technique. A collection of curves generally referred to by reference numeral 120 illustrates the effect of delaying the backlight illumination. As previously mentioned, backlight illumination delays executed by the system 90 are advantageous in preventing appearances of objectionable white flashes on a screen. Accordingly, curve 122 illustrates an exemplary un-modified backlight illumination square wave signal comprising portions 124 and 126. The curves 124 and 126 respectively denote backlight illumination operating at 100 and 50 percent brightness level. Curve 128 is a modified backlight square wave signal with similar operating brightness levels to that shown in curve 122 with an affixed one-frame time delay 134. The one-frame delay 134 is incurred by the backlight, as illustrated by the curve 128, when the backlight illumination display device 20 transitions from a low illumination level 126 to a high illumination level 124. In doing so, the system 90 extends the unmodified backlight 122 by one frame to produce curve 128.

Further, exemplary square wave signals of pixel brightness at the top and bottom of the screen are indicated by exemplary curves 136 and 144. These curves illustrate exemplary signals of pixels operating at 100 and 200 percent brightness levels. These operating brightness levels are indicated by respective curve portions 138 and 142. In an exemplary raster scanning of pixels executed throughout a video frame, for example, from the top to the bottom of a display screen, curve 144 has a time delay of one frame 135 relative to curve 136. The one frame delay 135 incurred by the pixels at the bottom of the screen is a result of the manner in which the pixels of the display device are raster scanned.

Advantageously, employing the time delays 134 and 135, objectionable white flashes may be eliminated, as illustrated by curves 146 and 152. These curves denote respective square wave signals of modified pixel brightness for the top and bottom of the screen, generated by multiplying curves 136 and 144 by the modified backlight illumination 128. As illustrated by these curves, delays 134 and 135 have the effect of reducing the overall brightness level from 100 to 50 percent for pixels at the top and bottom of the screen, as shown by respective curve portions 140 and 148. Consequently, to a viewer such an overall drop in intensity across a screen may be perceived as a “black flash”, which is much less objectionable than a white flash.

As system requirements may vary, the exemplary time delays 134 and 135 may be implemented in a manner that is different than the one depicted in FIG. 4. The time delays 134 and 135 may, for example, comprise an asymmetrical time delay applied to the backlight, as produced by system 90. Accordingly, these time delays are configured in accordance with transitions of the backlight throughout a video frame. This is beneficial in mitigating artifacts associated with the time misalignments of the pixel's raster scan and the backlight. Further, the time delays, as applied by the system 90, may eliminate artifacts associated with the inherent slow response time of the pixels disposed in the display device and with the response time of the illumination source itself.

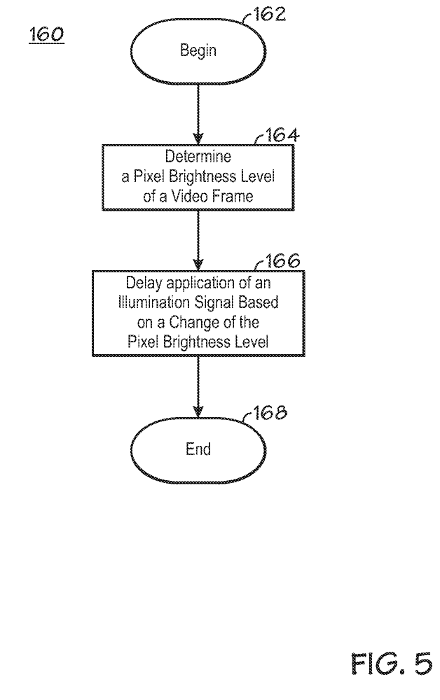

FIG. 5 is a flow chart 160 depicting a method for delaying the backlight illumination in accordance with embodiments of the present technique. The method begins at block 162 with pixel brightness data entering the white horizon finder 44 and the black horizon finder 45. Accordingly at block 164 pixel brightness level of a video frame is determined. Based on a change of the pixel brightness level, the illumination signal is delayed to the display device at block 166. Accordingly, the method ends at block 168.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A method of delaying an illumination signal, the method comprising:
determining a pixel brightness level for a video frame; and
delaying application of the illumination signal based on a change of the pixel brightness level.

2. The method recited in claim 1, comprising determining a brightest object of the video frame based on statistical data of pixel brightness.

3. The method recited in claim 1, comprising delaying the illumination signal selectively in accordance with changes of the pixel brightness level.

4. The method recited in claim 1, comprising delaying the application of the illumination signal asymmetrically in accordance with changes of the pixel brightness level.

5. The method recited in claim 1, comprising delaying the application of the illumination signal by one, two, or three frames based on the change in the pixel brightness level.

6. The method recited in claim 5, comprising producing a minimum illumination signal from an input illumination signal delayed by the one, two, or three frames.

7. The method recited in claim 1, comprising eliminating a white flash across a screen of the display device by delaying the application of the illumination signal.

8. The method recited in claim 1, comprising delaying the illumination signal while correcting gamma color pixel values of a display device.

9. The method recited in claim 1, comprising delaying the application of the illumination signal to compensate for a slow response time of a display device.

10. A video unit, comprising:
a video screen;
a first module configured to generate pixels across the video screen, wherein the first module is configured to change the brightness of the generated pixels; and
a second module configured to generate an illumination signal for the video screen, wherein the second module is configured to delay the illumination signal in response to changes in pixel brightness.

11. The video unit recited in claim 10, wherein a product of a signal output of the first module and of the second module eliminates a white flash across the video screen.

12. The video unit recited in claim 10, wherein the first module and the second module are adapted to operate simultaneously.

13. The video unit recited in claim 10, wherein the second module is adapted to delay the illumination signal of the video screen by one, two, or three frames.

14. The video unit recited in claim 13, wherein the first module is adapted to output a minimum illumination signal from an input illumination signal delayed by the one, two, or three frames.

15. The video unit recited in claim 10, wherein the second module is adapted to delay the illumination signal 18 for an amount of time corresponding to changes in the pixel brightness levels.

16. The video unit recited in claim 10, wherein the second module is adapted to delay the illumination signal to compensate for a slow response time of the video screen.

17. A system for delaying an illumination signal of a display device, comprising:
means for determining a pixel brightness level for a video frame; and
means for delaying application of the illumination signal based on a change of the pixel brightness level.

18. The system recited in claim 17, comprising means for eliminating a white flash across a screen of a display device by delaying the application of the illumination signal.

19. The system recited in claim 17, comprising means for delaying the application of the illumination signal by one, two, or three frames based on the change in the pixel brightness level.

20. The system recited in claim 19, comprising means for outputting a minimum illumination signal from an input illumination signal delayed by the one, two, or three frames.
